(19) United States
(12) Patent Application Publication
(10) Pub. No.: US 2007/0048525 A1
(43) Pub. Date: Mar. 1, 2007

(54) Method for forming plated coating, electromagnetic shielding member, and housing

(75) Inventors: Tadato Abe, Yamaguchi-Ken (JP); Norikazu Tsukada, Gunma-Ken (JP)

Correspondence Address: PILLSBURY WINTHROP SHAW PITTMAN, LLP, P.O. BOX 10500, MCLEAN, VA, 22102, US

(73) Assignees: KABUSHIKI KAISHA TOSHIBA, Tokyo (JP); CHUO KASEIHIN CO., INC., Tokyo (JP)

(21) Appl. No.: 11/509,038

(22) Filed: Aug. 24, 2006

(30) Foreign Application Priority Data
Feb. 24, 2004 (JP) 2004-048371

(51) Int. Cl. B05D 3/00; B05D 1/36; B32B 15/00

(52) U.S. Cl. 428/411.1; 427/305; 427/402; 428/692.1; 428/671

(57) ABSTRACT

A method for forming a plated coating according to the present invention includes a first step of degreasing and then rinsing a member made of a synthetic resin, a second step of applying a primer paint containing a catalyst onto the resulting member, a third step of forming a copper coating on a coating of the primer paint by an electroless plating process, and a fourth step of forming a rust preventive coating on the copper coating by benzotriazole treatment, those steps being performed in that order. An electromagnetic shielding member of the present invention includes the member treated in the above steps and a housing of the present invention also includes the member.

### CROSS-REFERENCE TO RELATED APPLICATION

This application is based upon and claims the benefit of priority from PCT application No. PCT/JP2005/003227 filed Feb. 21, 2005 and Japanese Patent Application No. 2004-48371, filed Feb. 24, 2004, the entire contents of which are incorporated herein by reference.

### BACKGROUND

1. Field

The present invention relates to methods for forming plated coatings, electromagnetic shielding members, and housings. The present invention particularly relates to a method for forming a plated coating having electromagnetic shielding properties, an-electromagnetic shielding member, and a housing.

2. Description of the related Art

In recent years, electronic devices have been greatly enhanced in performance and reduced in size and electronic circuits placed in such electronic devices, particularly digital circuits, have been enhanced in processing speed. Such digital circuits have been enhanced in packaging density. Therefore, in order to prevent electromagnetic waves emitted from the electronic devices from leaking out, electromagnetic shielding techniques are being strongly demanded.

Various electromagnetic shielding techniques have been developed. For example, Japanese Patent Application Publication (KOKAI) No. 2-228098 discloses a plating technique for covering the surface of a housing with a metal coating formed by an electroless plating process, which is particularly suitable for housings, made of synthetic resins, for electronic devices.

Examples of the electromagnetic shielding techniques include a metal sheet-joining technique for joining metal sheets to faces of a housing and a painting technique for applying electrically conductive paint onto such housing faces in addition to the plating technique. There are problems in that the metal sheet-joining technique is not suitable for electronic housings having various complicated shapes and carbon paint used in the painting technique is not useful in achieving high shielding properties (electromagnetic shielding effects).

On the other hand, the plating technique is useful in forming a metal coating, containing copper or another metal, having such high shielding properties on housing faces having arbitrary shapes.

The plating technique can be roughly classified into three categories: an electroplating process, a displacement plating process, and an electroless plating process. The electroless plating process is useful in forming metal coatings, having a uniform thickness and no pinholes, on housing faces having various complicated shapes and suitable for the electric housings made of synthetic resins (see, for example, Japanese Patent Application Publication (KOKAI) No. 2-228098).

Japanese Patent Application Publication (KOKAI) No. 2-228098 and Japanese Patent No. 2639120 disclose techniques for forming copper coatings on synthetic resins by electroless plating processes to prepare electromagnetic shielding members.

The outline of the technique disclosed in Japanese Patent Application Publication (KOKAI) No. 2-228098 will now be described with reference to FIG. 4.

A member 10 made of a non-conductive material such as a synthetic resin is degreased and rinsed, this step being referred to as Step 10. In this step, the member 10 is immersed in a solution containing, for example, sodium borate, sodium phosphate, and/or a surfactant.

Primer paint 20 is applied onto the resulting member 10, this step being referred to as Step 20. The primer paint 20 functions as a binder for bonding the member 10 to a copper coating formed by an electroless plating process. The primer paint 20 contains an acrylic urethane or an epoxy resin and metal particles, that is, nickel particles and iron particles.

The member 10 covered with a layer of the primer paint 20 is immersed in, for example, an acidic solution of palladium chloride, whereby palladium particles 30 each functioning as a catalyst are formed on the layer of the primer paint 20, this step being referred to as Step 30.

The member 10 covered with the palladium particles 30 is then immersed in an electroless plating solution containing copper sulfate. As a result, copper is deposited on the nickel particles and iron particles contained in the primer paint 20 by the catalytic effect of the palladium particles 30, whereby a copper coating 40 is formed, this step being referred to as Step 40.

The copper coating 40 has excellent shielding properties because copper has high conductivity, as is well known. However, copper is readily oxidized into copper oxides, which are dielectric materials (non-conductive materials). Therefore, when the copper coating 40 is partly oxidized, the oxidized portions that are dielectric materials function as slot antennas; hence, electromagnetic waves are propagated through the oxidized portions, whereby the electromagnetic shielding properties of the copper coating 40 are deteriorated.

In order to prevent the copper coating 40 from being oxidized, the copper coating 40 must be coated with a second metal layer containing, for example, nickel having higher oxidation resistance than copper.

However, the second metal layer cannot be directly formed on the copper coating 40 (see Japanese Patent Application Publication (KOKAI) No. 2-228098). Therefore, before the second metal layer is formed, the member 10 covered with the copper coating 40 is immersed in the solution containing the palladium particles 30, whereby the palladium particles 30 functioning as a catalyst are deposited on the copper coating 40, this step being referred to as Step 50.

The resulting member 10 is immersed in an electroless plating solution containing nickel sulfate, whereby a nickel coating 50 is formed over the palladium particles 30, this step being referred to as Step 60.

According to the above procedure, the following coatings are formed on the member 10 made of the synthetic resin in this order: the copper coating 40 having electromagnetic shielding properties and the nickel coating 50 for preventing copper oxidation.

In addition to the above technique, Japanese Patent No. 2639120 discloses the following technique: a step of subjecting the copper coating 40 to chromate treatment is used instead of the step of forming the nickel coating 50 for preventing copper oxidation, thereby providing a function of preventing copper oxidation, that is, a rust-preventive function.

In particular, a chromate coating functioning as a protective layer is formed on the copper coating 40 by the chromate treatment and an organic coating containing 1,2,3-benzotriazole is then formed on the chromate coating, thereby preventing the copper coating 40 from rusting.

WO-A 03/093534 discloses a rust preventive containing a hydroxyphenyl benzotriazole copolymer functioning as an active ingredient and a technique for preventing metal from rusting by the use of such a rust preventive.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic sectional view showing part of a housing according to the present invention;

FIG. 2 is a sectional view that illustrates steps of forming a copper coating according to the present invention and shows an electromagnetic shielding member according to the present invention;

FIG. 3 is a flow chart showing a procedure for forming the copper coating of the present invention; and

FIG. 4 is a sectional view illustrating steps of forming a copper coating by a known method.

### DETAILED DESCRIPTION

A method for forming a plated coating, an electromagnetic shielding member, and a housing according to the present invention will now be described with reference to the accompanying drawings.

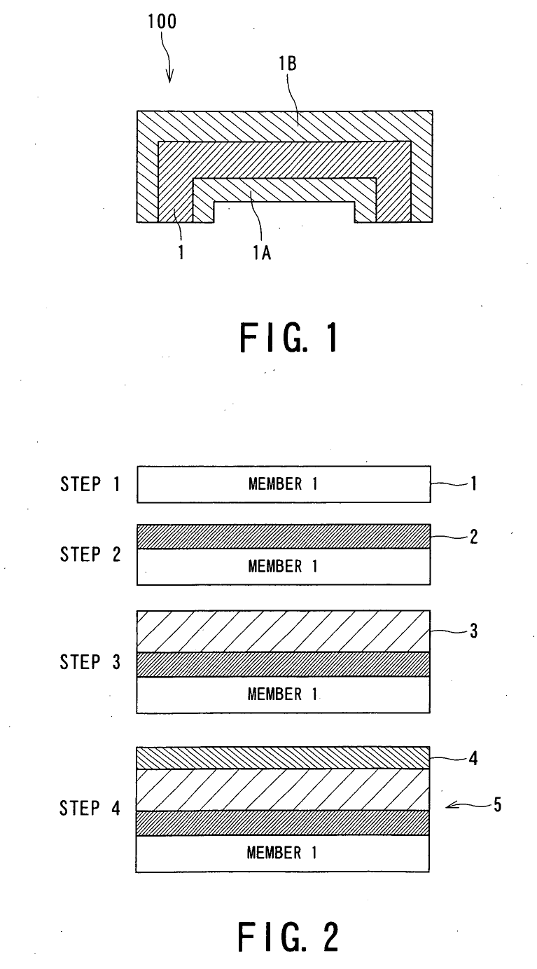

FIG. 1 is a schematic sectional view showing part of the housing of the present invention and reference numeral 100 represents the housing.

The housing 100 includes a member 1 made of a synthetic resin. The housing 100 is surface-treated to have electromagnetic shielding properties. Internal faces 1A of the housing 100 are covered with a coating principally containing copper, that is, the internal surface of the member 1 is covered with the copper coating.

External faces 1B of the housing 100, as well as the internal faces 1A, are covered with a coating principally containing copper. Alternatively, the external faces 1B may be coated with paint instead of the coating.

Such copper coatings have excellent electromagnetic shielding properties because copper has high electrical conductivity. Therefore, the housing 100 can prevent electromagnetic waves, emitted from an electronic device placed in the housing 100, from leaking out of the housing 100.

The synthetic resin contained in the member 1 is not particularly limited. Preferable examples of the synthetic resin include an acrylonitrile-butadiene-styrene (ABS) resin, a polyester resin, a polycarbonate resin, a polyurethane resin, and a polypropylene resin. Those resins have good moldability. The size and shape of the housing 100 may vary depending on the size and shape of the electronic device placed therein.

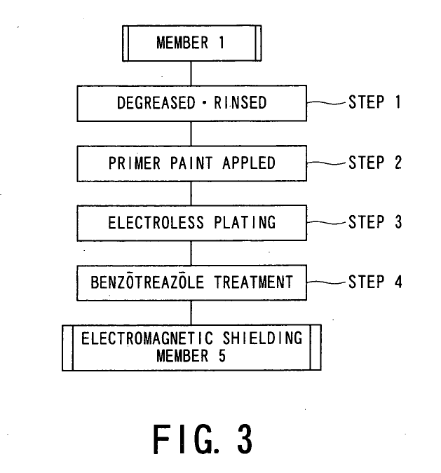

The method for forming a plated coating according to the present invention will now be described with reference to FIGS. 2 and 3. The method includes Steps 1 to 4 described below.

In Step 1, in order to remove a small amount of grease and/or finger prints remaining on a member 1, the member 1 is degreased and then rinsed. A known degreasing process and a known rising process can be used. The member 1 is usually degreased, for example, at about 40 to 60° C. for about three to ten minutes with a cleaning solution containing about 2% to 5% of sodium borate, about 2% to 5% of sodium phosphate, and about 0.2% to 2% of a surfactant on a weight per volume basis and then rinsed with water.

In Step 2, primer paint 2 is applied onto the resulting member 1. The primer paint 2 functions as a binder for bonding the member 1 to a copper coating formed by an electroless plating process, contains an acrylic urethane or an epoxy resin and a catalyst, and enhances the reactivity of copper.

The catalyst contains, for example, silver. The layer of the primer paint 2 applied onto the resulting member 1 has a thickness of about two to eight μm. The layer of the primer paint 2 is dried, whereby the layer is transformed into a coating.

In Step 3, the copper coating is formed on the coating of the primer paint 2 by the electroless plating process. The electroless plating process can be performed according to an ordinary procedure as follows: the member 1 covered with the coating of the primer paint 2 is degreased and then rinsed with water in the same manner as that described in Step 1 and the resulting member 1 is immersed in a copper plating solution at about 20° C. to 60° C. The immersion time depends on the desired thickness of the copper coating and is preferably ten to 60 minutes.

In Step 4, a rust preventive coating 4 is formed on the copper coating by benzotriazole treatment. In the treatment, the member 1 having the copper coating thereabove is immersed in a solution principally containing a benzotriazole compound. Benzotriazole compounds usually provide rust preventive properties to metal and particularly to copper and copper alloy.

The benzotriazole treatment is disclosed in WO-A 03/093534 in detail; hence, the description thereof is herein omitted.

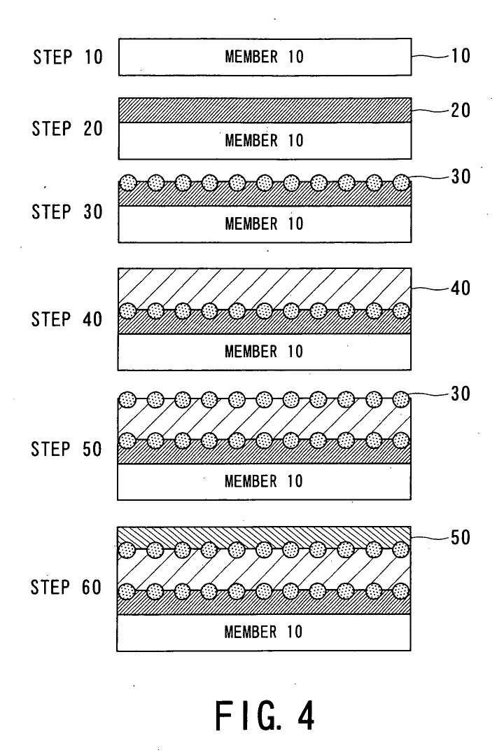

As described above, the copper coating having rust preventive properties can be formed above the member 1 by the method including Steps 1 to 4 that are simpler than the known steps shown in FIG. 4.

An electromagnetic shielding member 5 can be manufactured as follows: the member 1 made of the synthetic resin is treated in Steps 1 to 4, whereby the member 1 is covered with the copper coating having electromagnetic shielding properties and the copper coating is covered with rust preventive coating 4.

A housing, having electromagnetic shielding properties, for electronic devices can be manufactured as follows: the member 1 made of the synthetic resin is shaped into a housing component for electronic devices and then treated in Steps 1 to 4.

What is claimed is:

1. A method for forming a plated coating on a member made of a synthetic resin, comprising:
a step of degreasing and then rinsing the member;
a step of applying a primer paint containing a catalyst onto the resulting member;
a step of forming a copper coating on a coating of the primer paint by an electroless plating process; and
a step of forming a rust preventive coating on the copper coating by benzotriazole treatment, those steps being performed in that order.

2. The method according to claim 1, wherein the catalyst contains silver.

3. An electromagnetic shielding member comprising:
a member made of a synthetic resin;
a coating of a primer paint containing a catalyst, the coating being placed on the member;
a copper coating placed on the primer paint coating, the copper coating being formed by an electroless plating process; and
a rust preventive coating placed on the copper coating, the rust preventive coating being formed by benzotriazole treatment.

4. The electromagnetic shielding member according to claim 3, wherein the catalyst contains silver.

5. A housing comprising:
a housing member made of a synthetic resin;
a coating of a primer paint containing a catalyst, the coating being placed on the housing member;
a copper coating placed on the primer paint coating, the copper coating being formed by an electroless plating process; and
a rust preventive coating placed on the copper coating, the rust preventive coating being formed by benzotriazole treatment.

6. The housing according to claim 5, wherein the catalyst contains silver.
